(19) United States
(12) Patent Application Publication
(10) Pub. No.: US 2024/0179208 A1
(43) Pub. Date: May 30, 2024

(54) Selection of Primary Devices in Multi-Device Ecosystems

(71) Applicant: International Business Machines Corporation, Armonk, NY (US)

(72) Inventors: Tiberiu Suto, Franklin, NY (US); Jeremy R. Fox, Georgetown, TX (US); Tushar Agrawal, West Fargo, ND (US); Sarbajit K. Rakshit, Kolkata (IN)

(21) Appl. No.: 18/058,978

(22) Filed: Nov. 28, 2022

(51) Int. Cl. H04L 67/1095; G05B 19/04

(52) U.S. Cl. CPC H04L 67/1095; G05B 19/04

(57) ABSTRACT

Multi-device ecosystem management is provided. A plurality of devices in a multi-device ecosystem, including a set of specifications and a relative position corresponding to each respective device of the plurality of devices, are identified. The multi-device ecosystem works together to perform an activity. A primary device is selected from the plurality of devices in the multi-device ecosystem based on an analysis of the set of specifications and the relative position corresponding to each respective device. The primary device has sufficient data processing capabilities to coordinate and control actions of secondary devices in the multi-device ecosystem and has a communication connection with each of the secondary devices to facilitate completion of the activity. A set of requirements to complete the activity by the multi-device ecosystem is determined. The activity is completed in accordance with the set of requirements by the multi-device ecosystem as coordinated and controlled by the primary device.

### BACKGROUND

### 1. Field

The disclosure relates generally to multi-device ecosystems and more specifically to enhanced selection of a primary device in a multi-device ecosystem based on analysis of device specifications, device relative location within the multi-device ecosystem, and device knowledge corpus corresponding to each respective device of the multi-device ecosystem.

### 2. Description of the Related Art

In a multi-device ecosystem, a variety of devices interact with one another as an ecosystem within an environment, such as, for example, a building, office, store, warehouse, farm, field, forest, amusement park, city, airport, manufacturing plant, machine shop, industrial complex, or the like. The variety of devices can have diverse functionalities and perform diverse activities. The devices communicate with one another using communication links.

### SUMMARY

According to one illustrative embodiment, a computer-implemented method for multi-device ecosystem management is provided. A plurality of devices in a multi-device ecosystem, including a set of specifications and a relative position corresponding to each respective device of the plurality of devices, are identified. The multi-device ecosystem works together to perform an activity. A primary device is selected from the plurality of devices in the multi-device ecosystem based on an analysis of the set of specifications and the relative position corresponding to each respective device. The primary device has sufficient data processing capabilities to coordinate and control actions of secondary devices in the multi-device ecosystem and has a communication connection with each of the secondary devices to facilitate completion of the activity. A set of requirements to complete the activity by the multi-device ecosystem is determined. The activity is completed in accordance with the set of requirements by the multi-device ecosystem as coordinated and controlled by the primary device. According to other illustrative embodiments, a multi-device ecosystem and computer program product for multi-device ecosystem management are provided.

### BRIEF DESCRIPTION OF THE DRAWINGS

FIG. 1 is a pictorial representation of a computing environment in which illustrative embodiments may be implemented;

FIG. 2 is a diagram illustrating an example of a multi-device ecosystem management process in accordance with an illustrative embodiment;

FIG. 3 is a flowchart illustrating a process for performing an activity in a multi-device ecosystem in accordance with an illustrative embodiment; and

FIG. 4 is a flowchart illustrating a process for managing primary devices in a multi-device ecosystem in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

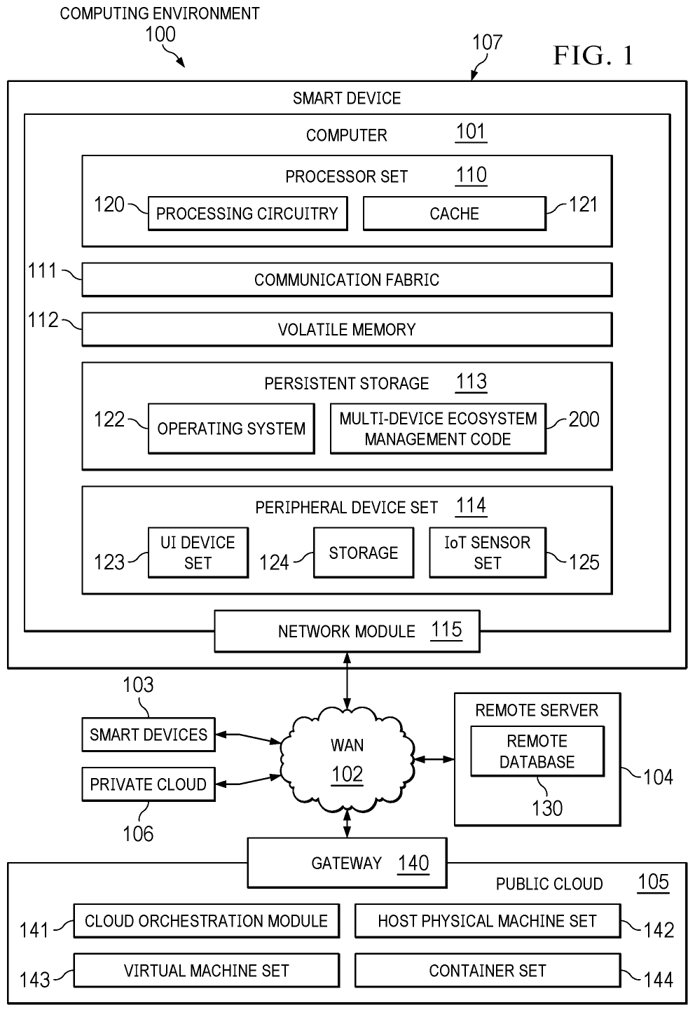

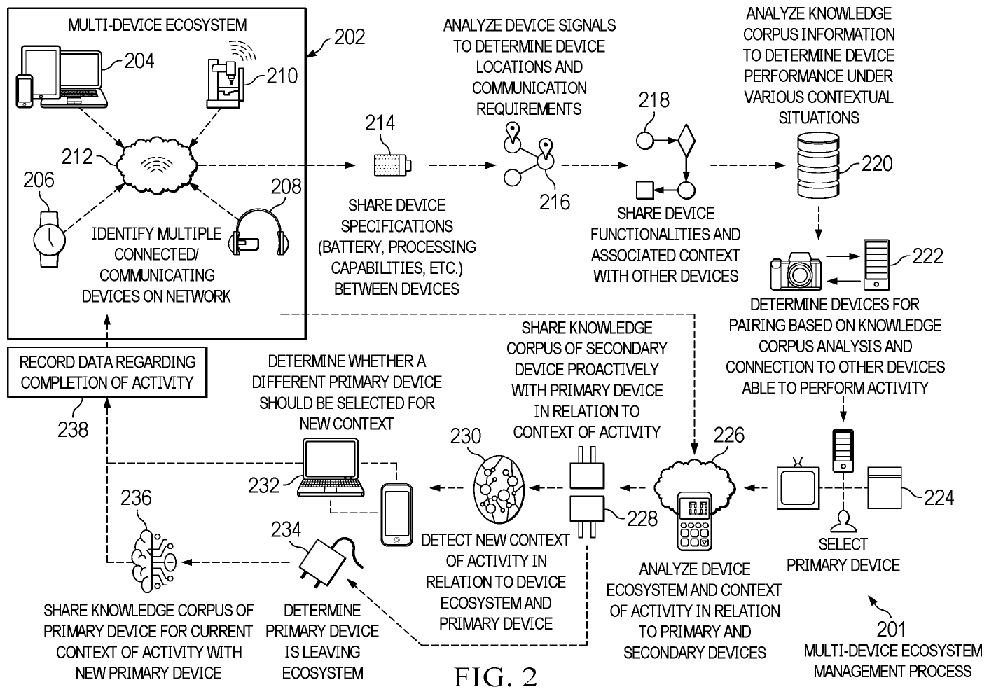

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as multi-device ecosystem management code 200. For example, multi-device ecosystem management code 200 generates a knowledge corpus of device specifications, device health status, device availability, relative device position, device capabilities, and the like corresponding to each respective “smart device” of a multi-device ecosystem. A smart device as used herein includes at least a processor, memory, storage, and communication component. In addition, the multi-device ecosystem can include mobile smart devices, stationary smart devices, or a combination of mobile and stationary smart devices. It should be noted that multi-device ecosystem management code 200 is implemented in each respective smart device of the multi-device ecosystem.

Multi-device ecosystem management code 200 utilizes the information contained in the knowledge corpuses to identify an appropriate smart device to be selected as a “primary device” for a particular contextual situation corresponding to performance of an activity. A primary device as used herein coordinates and controls actions of secondary devices in the multi-device ecosystem to perform an activity. The contextual situation is the current context of the activity, such as, for example, date, time, weather, type of environment, description of environment, size of environment, type of objects involved, whether humans are present in environment, and the like. The activity can be any type of activity that the multi-device ecosystem can perform, such as, for example, moving objects, building objects, manufacturing objects, transporting objects, maintaining objects, monitoring objects, cleaning objects, assisting other devices, assisting humans, or the like. Furthermore, an activity can be composed of a plurality of tasks, each task performed by the same multi-device ecosystem or a different multi-device ecosystem (e.g., a different set of smart devices having different functionalities).

The primary smart device, which multi-device ecosystem management code 200 selected based on analyzing the set of specifications and relative position corresponding to the primary smart device, coordinates and controls the actions of the secondary smart devices in the multi-device ecosystem to perform the activity. Multi-device ecosystem management code 200 collects and records data on how the different smart devices perform activities under different contextual situations to update the information contained in each of the knowledge corpuses. Multi-device ecosystem management code 200 also takes into account the growth of the multi-device ecosystem (e.g., number of smart devices, relative position and distance between smart devices, and the like) to generate device subgroups with multiple primary devices (i.e., one primary device for each subgroup of smart devices) as needed for different contextual situations. Alternatively, multi-device ecosystem management code 200 identifies a “relay secondary device” that can receive commands from the primary smart device and relay those commands to other secondary smart devices that are on the edge of the multi-device ecosystem (e.g., beyond communication range of the primary smart device). Further, multi-device ecosystem management code 200 dynamically modifies the configuration of the multi-device ecosystem by adding and removing devices (including both primary and secondary smart devices) from the multi-device ecosystem as needed.

In addition to multi-device ecosystem management code block 200, computing environment 100 includes, for example, computer 101, wide area network (WAN) 102, smart devices 103, remote server 104, public cloud 105, and private cloud 106. In this embodiment, computer 101 is implemented in smart device 107 and includes processor set 110 (including processing circuitry 120 and cache 121), communication fabric 111, volatile memory 112, persistent storage 113 (including operating system 122 and multi-device ecosystem management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of any type of computer now known or to be developed in the future that is capable of running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Smart device 107 may be coupled to a cloud, even though it is not shown in a cloud in FIG. 1. On the other hand, smart device 107 is not required to be coupled to a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods are stored in multi-device ecosystem management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The multi-device ecosystem management code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

Smart devices 103, along with smart device 107, comprise the multi-device ecosystem. Smart devices 103 can be the same as or similar to smart device 107 in structure and functionality. Alternatively, smart devices 103 can include a combination of different structures and functionalities. A user, such as, for example, a system administrator, can request performance of an activity by the multi-device ecosystem (i.e., smart device 107 and smart devices 103).

Smart devices 103 receive commands from the operations of computer 101 on smart device 107 utilizing multi-device ecosystem management code 200. For example, in a hypothetical case where smart device 107 is selected as a primary device and smart devices 103 are assigned as secondary devices to perform the activity, smart device 107 issues commands to smart devices 103 to coordinate and control performance of that particular activity by smart devices 103. Typically, smart device 107 issues the commands from network module 115 of computer 101 through WAN 102 to smart devices 103.

Remote server 104 is any computer system that serves at least some data and/or functionality to computer 101. Remote server 104 may be controlled and used by the same entity that operates smart device 107 and smart devices 103. Remote server 104 represents the machine(s) that collect and store helpful and useful data for use by other computers, such as computer 101 in smart device 107 and the computers in smart devices 103. For example, in a hypothetical case where computer 101 is designed and programmed to provide a prediction based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In a multi-device ecosystem, smart devices collaborate with each other to perform an activity. In this case, one device in the multi-device ecosystem is designated as a primary device and the other devices are designated as secondary devices. The secondary devices receive commands from the primary device so that the activity is performed in a synchronized and efficient manner. Each smart device has data processing capabilities and memory to perform its own computations. These smart devices also create ad-hoc communication connectivity with other smart devices to manage the ecosystem.

However, to be a primary device, that particular smart device needs to have sufficient data processing capabilities to analyze the data feeds from all of the secondary devices in the multi-device ecosystem. If an inappropriate primary device is selected, then controlling the secondary devices in the multi-device ecosystem will be difficult and performance of the activity will be decreased (e.g., inefficient and possibly ineffective).

Illustrative embodiments, in any multi-device ecosystem, share device specification information corresponding to the smart devices in the multi-device ecosystem with each other, along with device relative position within the multi-device ecosystem, current device health status, and the like. By sharing this information between the smart devices, illustrative embodiments are capable of identifying an appropriate primary device for any multi-device ecosystem. Each respective secondary device of the multi-device ecosystem proactively sends a data stream to the primary device in order for the primary device to coordinate and control the secondary devices effectively and efficiently during performance of the activity.

The smart devices of the multi-device ecosystem communicate with each other via at least one of wireless communication links or wired communication links to share information, such as, for example, specifications, health status, availability, relative position, communication capabilities, knowledge corpus, and the like. The specification information includes, for example, device data processing capabilities, device available memory, device available storage, device available battery power, and the like corresponding to that particular device. Health status information includes, for example, whether that particular device is currently experiencing a hardware, software, or other problem or whether that particular device is healthy (i.e., not currently experiencing any issues). Availability information includes, for example, predicted availability of that particular device to participate in the activity (e.g., the device predicts it will be available for 5 minutes, 15 minutes, 30 minutes, 45 minutes, 60 minutes, or any other interval of time). Relative position information includes, for example, that particular device's relative position to other devices within the multi-device ecosystem. Communication capability information includes, for example, that particular device's ability to connect communicatively with other devices in the multi-device ecosystem (e.g., Wi-Fi, Near Field Communication, Bluetooth technology, network interface card, modem, or the like). Knowledge corpus information includes, for example, that particular device's ability to perform different activities under different contextual situations.

Smart devices in the multi-device ecosystem analyze the shared information in the knowledge corpus of each respective device regarding historical performance of different activities under different contextual situations to determine completeness of the information in each respective knowledge corpus. As a result, the smart devices are able to determine whether one or more of the smart devices need to transfer additional information to the knowledge corpus of the selected primary device in order for the selected primary device to have needed relevant information to coordinate and control the actions of the secondary devices to perform the activity under the current contextual situation corresponding to the activity.

In addition, illustrative embodiments rotate primary devices when the current contextual situation corresponding to the activity evolves or changes. The smart devices in the multi-device ecosystem continue to monitor the specifications, current health status, predicted availability, relative position, communication capability, and knowledge corpus of each respective smart device in the multi-device ecosystem in relation to the new contextual situation to determine whether another primary device should be selected to coordinate and control the secondary devices in the new contextual situation. In other words, the multi-device ecosystem can designate a different smart device for the role of primary device for the new contextual situation.

Further, illustrative embodiments can identify a primary device with multiple other primary devices. For example, based on the growth of the multi-device ecosystem (e.g., relative position and distance between smart devices in the ecosystem), illustrative embodiments can identify a plurality of primary devices, assign a particular primary device of the plurality of primary devices to a particular contextual situation corresponding to the activity, and assign an appropriate number of secondary devices to that particular primary device to perform the activity in that particular contextual situation.

Furthermore, based on the specifications, relative position, and communication capability of each respective smart device in the multi-device ecosystem, illustrative embodiments determine whether the selected primary device needs a relay secondary device to transfer commands from the primary device to other secondary devices so that the primary device can coordinate and control performance of the activity by the entire multi-device ecosystem when certain smart devices are beyond communication range of the primary device.

Moreover, illustrative embodiments provide knowledge corpus management for all primary devices. For example, in response to a primary device in any contextual situation needing to leave the multi-device ecosystem, illustrative embodiments proactively select a replacement primary device and then transfer the knowledge corpus of the leaving primary device to the selected replacement primary device so that the replacement primary device can continue coordination and control of the secondary devices in performance of the activity without interruption.

Illustrative embodiments implement a plurality of different stages to form the multi-device ecosystem to perform the activity. For example, in a first stage, illustrative embodiments establish the multi-device ecosystem to perform that particular activity. Each smart device in the multi-device ecosystem identifies itself using a unique identifier. In addition, each smart device shares its device specification information (e.g., data processing capabilities, available memory, available storage, available battery power, communication capabilities, and the like) with the other smart devices. Further, each smart device shares its relative position with the other smart devices and distance from the other smart devices. Furthermore, each smart device shares its knowledge corpus regarding historical performance of different activities under different contextual situations.

In a second stage, illustrative embodiments establish interaction and collaboration between the smart devices in the multi-device ecosystem. For example, the smart devices interact and collaborate with each other by streaming data between smart devices. Based on shared relative positions of the devices and distances from each other, illustrative embodiments determine device-to-device communications. For example, based on relative positions and distances of the smart devices in the multi-device ecosystem, illustrative embodiments determine which smart device can connect to all the other smart devices in the multi-device ecosystem.

In a third stage, illustrative embodiments identify and designate a primary device for the multi-device ecosystem. Illustrative embodiments identify the requirements to perform and complete the activity (e.g., date and time to complete activity, number of smart devices needed to complete activity, needed functionality of the smart devices to perform activity, and the like). Illustrative embodiments also identify the primary device to coordinate and control the secondary devices of the multi-device ecosystem during performance of the activity based on the activity requirements. The primary device has sufficient data processing capabilities to coordinate and control the secondary devices, has communication connectivity with all of the secondary devices, and has sufficient battery power to complete the activity for a predicted duration of time.

In a fourth stage, illustrative embodiments establish the relationship between the designated primary device and the assigned secondary devices of the multi-device ecosystem. In response to designating the primary device, illustrative embodiments determine whether an information gap exists in the knowledge corpus of the primary device regarding the current contextual situation corresponding to performance of the activity. Illustrative embodiments determine whether the information that is absent from the knowledge corpus of the primary device is present in a knowledge corpus of one of the secondary devices. The secondary device having the needed information supplements the primary device by proactively sending the needed information to the knowledge corpus of the primary device so that the primary device can now coordinate and control the secondary devices in performance of the activity for that particular contextual situation. In other words, illustrative embodiments identify those devices having different knowledge corpus levels to perform different activities under different contextual situations and then pass that information on to the other devices.

In a fifth stage, illustrative embodiments can designate multiple primary devices based on different contextual situations corresponding to the activity. In other words, illustrative embodiments designate multiple primary devices during performance of the activity, each primary device addressing a different contextual situation corresponding to the activity. Illustrative embodiments identify each different contextual situation corresponding to the activity and accordingly designate the appropriate primary device for that particular contextual situation. The designated primary device sends command signals to each of the secondary devices assigned to that particular primary device. When the multi-device ecosystem grows beyond a threshold level (e.g., number of devices, distance between devices, or the like causing decreased performance of the multi-device ecosystem or inability of the primary device to continue coordinating and controlling assigned secondary devices), illustrative embodiments segment or divide the devices into two or more other multi-device ecosystems to continue performing the activity based on the spreading pattern of the devices. Also, based on the spreading pattern of the devices, illustrative embodiments designate an appropriate primary device to each of the two or more other multi-device ecosystems.

In a sixth stage, in response to predicting that the current primary device is leaving the multi-device ecosystem, illustrative embodiments identify an alternate primary device to replace the leaving primary device. The leaving primary device proactively migrates the knowledge corpus of the leaving primary to the alternate primary device for continuous coordination and control of the secondary devices in performance of the activity.

In a seventh stage, illustrative embodiments collect and record data regarding the completion of the activity by the designated primary device and the assigned secondary devices. Illustrative embodiments update the knowledge corpus of each respective device of the multi-device ecosystem with the collected data regarding the completion of the activity for future reference. Further, illustrative embodiments update the specifications corresponding to each respective device of the multi-device ecosystem based on the collected data regarding the completion of the activity.

Moreover, each device can generate a list of its own components and specifications to a level of, for example, circuit board type and manufacturer, processor type and manufacturer, memory type and manufacturer, storage type and manufacturer, communication component type and manufacturer, and the like. In some illustrative embodiments, the component and specification list is linked to a specific device identifier and included as a blockchain record tracing the origin of each component. Also, each device can capture and record any faults that cause resets or errors during performance of an activity by that particular device for further analysis. In addition, illustrative embodiments can utilize crowdsourced analysis of recorded faults via anonymized data from multiple entities in order to identify patterns linking certain device components to different issues that have occurred. Further, illustrative embodiments can utilize the result of the crowdsourced analysis to determine which devices are more likely to have a failure and, therefore, should be less likely to be selected as a primary device. Furthermore, illustrative embodiments can select a secondary device as a backup primary device in the event of primary device failure for real time failover capability. Illustrative embodiments can also share extra data processing capabilities between different types of smart devices when defined security protocols are met.

Thus, illustrative embodiments provide one or more technical solutions that overcome a technical problem with selection of an appropriate primary device to coordinate and control actions of secondary devices to perform an activity under different contextual situations in an effective and efficient manner. As a result, these one or more technical solutions provide a technical effect and practical application in the field of multi-device ecosystems.

With reference now to FIG. 2, a diagram illustrating an example of a multi-device ecosystem management process is depicted in accordance with an illustrative embodiment. Multi-device ecosystem management process 201 may be implemented in a computing environment, such as computing environment 100 in FIG. 1.

In this example, multi-device ecosystem management process 201 includes multi-device ecosystem 202, which is comprised of smart device 204, smart device 206, smart device 208, and smart device 210 connected via network 212. Smart devices 204-210 may be, for example, smart device 107 and smart devices 103 in FIG. 1. Network 212 may be, for example, WAN 102 in FIG. 2.

In this example, smart device 204 is one of a laptop computer, a tablet computer, smart phone, or the like. Smart device 206 is a smart watch. Smart device 208 is a smart glass. Smart device 210 is a smart drill press. However, it should be noted that multi-device ecosystem 202 is intended as an example only and not as a limitation on illustrative embodiments. In other words, multi-device ecosystem 202 may include any number and types of smart devices. Furthermore, multi-device ecosystem management process 201 can include any number of multi-device ecosystems comprised of different groups of smart devices.

Smart devices 204-210 of multi-device ecosystem 202 work together to perform an activity specified by a user, such as, for example, a system administrator. Smart devices 204-210 utilize a unique identifier to identify each other. At 214, smart devices 204-210 share device specifications with each other. At 216, smart devices 204-210 analyze streaming device signals to determine relative device locations and communication requirements between the devices. At 218, smart devices 204-210 share device functionalities and associated context with each other.

At 220, smart devices 204-210 analyze device knowledge corpus information to determine device activity performance under various contextual situations. At 222, smart devices 204-210 determine devices for pairing based on knowledge corpus analysis and connection to other devices able to perform the activity. At 224, smart devices 204-210 select a primary device (e.g., smart device 204) to coordinate and control actions of secondary devices (e.g., smart devices 206-210) to perform the activity.

At 226, smart devices 204-210 analyze multi-device ecosystem 202 and the context of the activity in relation to the primary device and the secondary devices. At 228, one or more secondary devices proactively share knowledge corpus information with the primary device in relation to the context of the activity. At 230, smart devices 204-210 detect a new context of the activity in relation to multi-device ecosystem 202 and the primary device. At 232, smart devices 204-210 determine whether a different primary device should be selected for the new context of the activity.

At 234, smart devices 204-210 determine that the primary device is leaving multi-device ecosystem 202. At 236, the primary device leaving multi-device ecosystem 202 shares its knowledge corpus for the current context of the activity with a newly selected primary device in order for the newly selected primary device to continue coordinating and controlling the secondary devices to complete the activity. At 238, smart devices 204-210 record data regarding the completion of the activity under the current context and update corresponding knowledge corpuses with the recorded data.

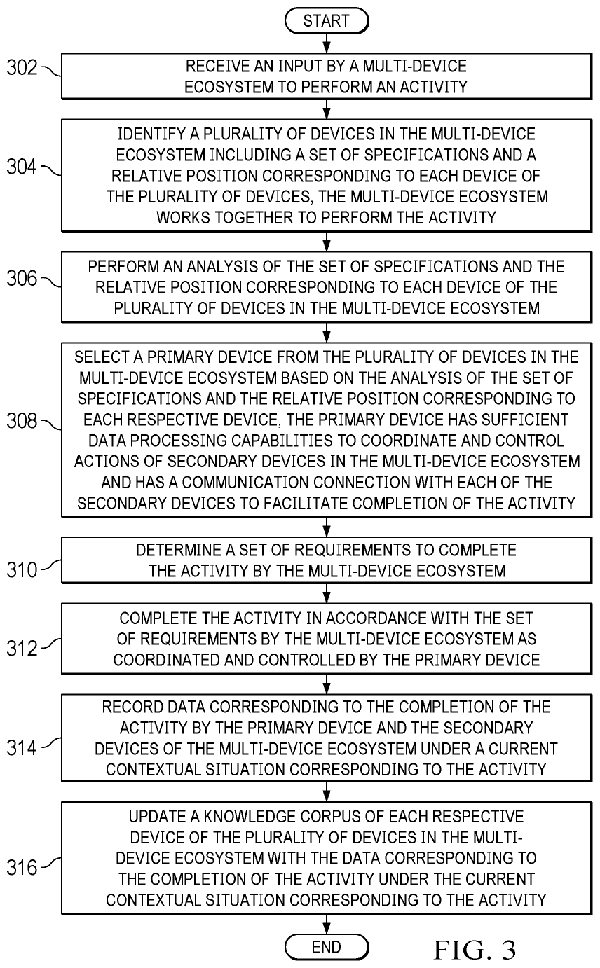

With reference now to FIG. 3, a flowchart illustrating a process for performing an activity in a multi-device ecosystem is shown in accordance with an illustrative embodiment. The process shown in FIG. 3 may be implemented in computing environment 100 in FIG. 1 or multi-device ecosystem 202 in FIG. 2. For example, the process shown in FIG. 3 may be implemented utilizing multi-device ecosystem management code 200 in FIG. 1.

The process begins when the multi-device ecosystem receives an input to perform an activity (step 302). The multi-device ecosystem identifies a plurality of devices in the multi-device ecosystem including a set of specifications and a relative position corresponding to each device of the plurality of devices (step 304). The multi-device ecosystem works together to perform the activity. The multi-device ecosystem performs an analysis of the set of specifications and the relative position corresponding to each device of the plurality of devices in the multi-device ecosystem (step 306).

The multi-device ecosystem selects a primary device from the plurality of devices in the multi-device ecosystem based on the analysis of the set of specifications and the relative position corresponding to each respective device (step 308). The devices comprising the multi-device ecosystem come to a consensus as to which particular device of the group is to act as the primary device based on the analysis. The remaining devices of the group are secondary devices. The primary device has sufficient data processing capabilities to coordinate and control actions of the secondary devices in the multi-device ecosystem and has a communication connection with each of the secondary devices to facilitate completion of the activity.

The multi-device ecosystem determines a set of requirements to complete the activity (step 310). The multi-device ecosystem performs and completes the activity in accordance with the set of requirements as coordinated and controlled by the primary device (step 312). The multi-device ecosystem records data corresponding to the completion of the activity by the primary device and the secondary devices of the multi-device ecosystem under a current contextual situation corresponding to the activity (step 314). The multi-device ecosystem updates a knowledge corpus of each respective device of the plurality of devices in the multi-device ecosystem with the data corresponding to the completion of the activity under the current contextual situation corresponding to the activity (step 316). Thereafter, the process terminates.

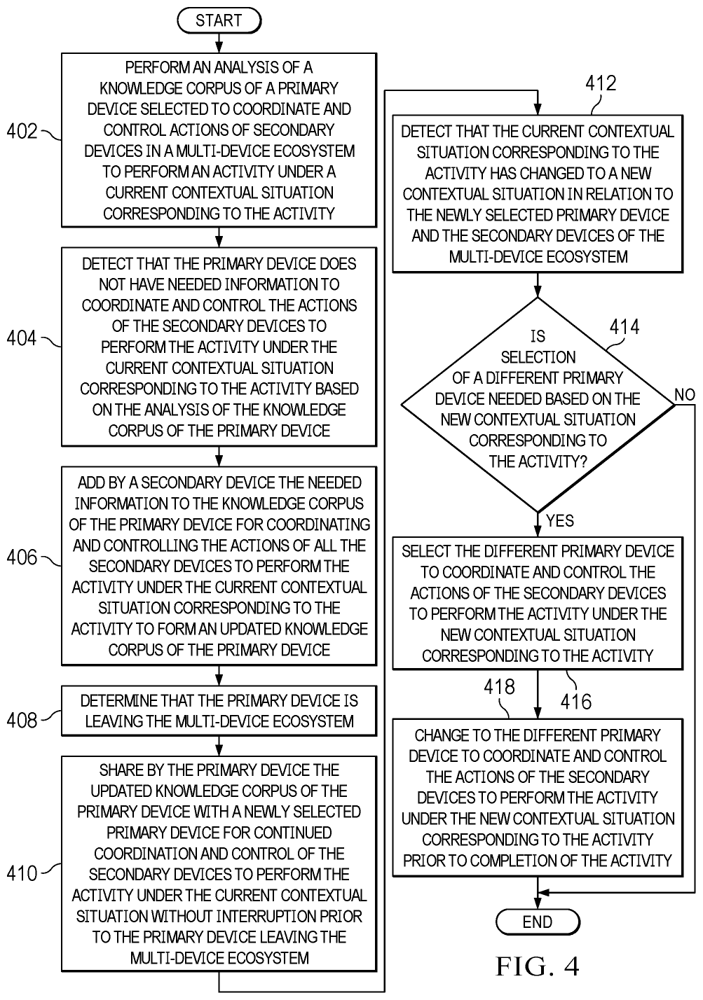

With reference now to FIG. 4, a flowchart illustrating a process for managing primary devices in a multi-device ecosystem is shown in accordance with an illustrative embodiment. The process shown in FIG. 4 may be implemented in computing environment 100 in FIG. 1 or multi-device ecosystem 202 in FIG. 2. For example, the process shown in FIG. 4 may be implemented utilizing multi-device ecosystem management code 200 in FIG. 1.

The process begins when the multi-device ecosystem performs an analysis of a knowledge corpus of a primary device selected to coordinate and control actions of secondary devices to perform an activity under a current contextual situation corresponding to the activity (step 402). The multi-device ecosystem detects that the primary device does not have needed information to coordinate and control the actions of the secondary devices to perform the activity under the current contextual situation corresponding to the activity based on the analysis of the knowledge corpus of the primary device (step 404). A secondary device of the multi-device ecosystem adds the needed information to the knowledge corpus of the primary device for coordinating and controlling the actions of all the secondary devices to perform the activity under the current contextual situation corresponding to the activity to form an updated knowledge corpus of the primary device (step 406).

Subsequently, the multi-device ecosystem determines that the primary device is leaving the multi-device ecosystem (step 408). The primary device of the multi-device ecosystem shares the updated knowledge corpus of the primary device with a newly selected primary device for continued coordination and control of the secondary devices to perform the activity under the current contextual situation without interruption prior to the primary device leaving the multi-device ecosystem (step 410).

Afterward, the multi-device ecosystem detects that the current contextual situation corresponding to the activity has changed to a new contextual situation in relation to the newly selected primary device and the secondary devices of the multi-device ecosystem (step 412). The multi-device ecosystem makes a determination as to whether selection of a different primary device is needed based on the new contextual situation corresponding to the activity (step 414). If the multi-device ecosystem determines that selection of a different primary device is not needed based on the new contextual situation corresponding to the activity, no output of step 414, then the process terminates thereafter. If the multi-device ecosystem determines that selection of a different primary device is needed based on the new contextual situation corresponding to the activity, yes output of step 414, then the multi-device ecosystem selects the different primary device to coordinate and control the actions of the secondary devices to perform the activity under the new contextual situation corresponding to the activity (step 416). The multi-device ecosystem then changes to the different primary device to coordinate and control the actions of the secondary devices to perform the activity under the new contextual situation corresponding to the activity prior to completion of the activity (step 418). The completion of the activity includes identification of each different contextual situation addressed by each different primary device to coordinate and control the completion of the activity by the multi-device ecosystem. Thereafter, the process terminates.

Thus, illustrative embodiments of the present invention provide a computer-implemented method, computer system, and computer program product for enhanced selection of a primary device in a multi-device ecosystem based on analysis of device specifications, device relative location within the multi-device ecosystem, and device knowledge corpus corresponding to each respective device of the multi-device ecosystem. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for multi-device ecosystem management, the computer-implemented method comprising:
identifying a plurality of devices in a multi-device ecosystem, including a set of specifications and a relative position corresponding to each respective device of the plurality of devices, wherein the multi-device ecosystem works together to perform an activity;
selecting a primary device from the plurality of devices in the multi-device ecosystem based on an analysis of the set of specifications and the relative position corresponding to each respective device, wherein the primary device has sufficient data processing capabilities to coordinate and control actions of secondary devices in the multi-device ecosystem and has a communication connection with each of the secondary devices to facilitate completion of the activity;
determining a set of requirements to complete the activity by the multi-device ecosystem; and
completing the activity in accordance with the set of requirements by the multi-device ecosystem as coordinated and controlled by the primary device.

2. The computer-implemented method of claim 1, further comprising:
recording data corresponding to the completion of the activity by the primary device and the secondary devices of the multi-device ecosystem under a current contextual situation corresponding to the activity; and
updating a knowledge corpus of each respective device of the plurality of devices in the multi-device ecosystem with the data corresponding to the completion of the activity under the current contextual situation corresponding to the activity.

3. The computer-implemented method of claim 1, further comprising:
performing an analysis of a knowledge corpus of the primary device selected to coordinate and control actions of the secondary devices to perform the activity under a current contextual situation corresponding to the activity;
detecting that the primary device does not have needed information to coordinate and control the actions of the secondary devices to perform the activity under the current contextual situation corresponding to the activity based on the analysis of the knowledge corpus of the primary device; and
adding by a secondary device the needed information to the knowledge corpus of the primary device for coordinating and controlling the actions of the secondary devices to perform the activity under the current contextual situation corresponding to the activity.

4. The computer-implemented method of claim 1, further comprising:
determining that the primary device is leaving the multi-device ecosystem; and
sharing by the primary device a knowledge corpus of the primary device with a newly selected primary device for continued coordination and control of the secondary devices to perform the activity under a current contextual situation without interruption prior to the primary device leaving the multi-device ecosystem.

5. The computer-implemented method of claim 1, further comprising:
detecting that a current contextual situation corresponding to the activity has changed to a new contextual situation in relation to the primary device and the secondary devices of the multi-device ecosystem;
determining whether selection of a different primary device is needed based on the new contextual situation corresponding to the activity; and
selecting the different primary device to coordinate and control the actions of the secondary devices to perform the activity under the new contextual situation corresponding to the activity in response to determining that selection of the different primary device is needed based on the new contextual situation corresponding to the activity.

6. The computer-implemented method of claim 5, further comprising:
changing to the different primary device to coordinate and control the actions of the secondary devices to perform the activity under the new contextual situation corresponding to the activity prior to completion of the activity.

7. The computer-implemented method of claim 1, wherein the completion of the activity includes identification of each different contextual situation addressed by each different primary device to coordinate and control the completion of the activity by the multi-device ecosystem.

8. The computer-implemented method of claim 1, further comprising:
identifying a relay secondary device that can receive commands from the primary device; and
relaying by the relay secondary device the commands to other secondary devices in the multi-device ecosystem that are beyond communication range of the primary device.

9. The computer-implemented method of claim 1, further comprising:
sending by each of the secondary devices in the multi-device ecosystem a data stream to the primary device in order for the primary device to coordinate and control the secondary devices effectively and efficiently during performance of the activity.

10. A multi-device ecosystem for multi-device ecosystem management, the multi-device ecosystem comprising:
a communication fabric;
a set of storage devices connected to the communication fabric, wherein the set of storage devices stores program instructions; and
a set of processors connected to the communication fabric, wherein the set of processors executes the program instructions to:
identify a plurality of devices in a multi-device ecosystem, including a set of specifications and a relative position corresponding to each respective device of the plurality of devices, wherein the multi-device ecosystem works together to perform an activity;
select a primary device from the plurality of devices in the multi-device ecosystem based on an analysis of the set of specifications and the relative position corresponding to each respective device, wherein the primary device has sufficient data processing capabilities to coordinate and control actions of secondary devices in the multi-device ecosystem and has a communication connection with each of the secondary devices to facilitate completion of the activity;
determine a set of requirements to complete the activity by the multi-device ecosystem; and
complete the activity in accordance with the set of requirements by the multi-device ecosystem as coordinated and controlled by the primary device.

11. The multi-device ecosystem of claim 10, wherein the set of processors further executes the program instructions to:
record data corresponding to the completion of the activity by the primary device and the secondary devices of the multi-device ecosystem under a current contextual situation corresponding to the activity; and
update a knowledge corpus of each respective device of the plurality of devices in the multi-device ecosystem with the data corresponding to the completion of the activity under the current contextual situation corresponding to the activity.

12. The multi-device ecosystem of claim 10, wherein the set of processors further executes the program instructions to:
perform an analysis of a knowledge corpus of the primary device selected to coordinate and control actions of the secondary devices to perform the activity under a current contextual situation corresponding to the activity;
detect that the primary device does not have needed information to coordinate and control the actions of the secondary devices to perform the activity under the current contextual situation corresponding to the activity based on the analysis of the knowledge corpus of the primary device; and
add by a secondary device the needed information to the knowledge corpus of the primary device for coordinating and controlling the actions of the secondary devices to perform the activity under the current contextual situation corresponding to the activity.

13. The multi-device ecosystem of claim 10, wherein the set of processors further executes the program instructions to:
determine that the primary device is leaving the multi-device ecosystem; and
share by the primary device a knowledge corpus of the primary device with a newly selected primary device for continued coordination and control of the secondary devices to perform the activity under a current contextual situation without interruption prior to the primary device leaving the multi-device ecosystem.

14. The multi-device ecosystem of claim 10, wherein the set of processors further executes the program instructions to:
detect that a current contextual situation corresponding to the activity has changed to a new contextual situation in relation to the primary device and the secondary devices of the multi-device ecosystem;
determine whether selection of a different primary device is needed based on the new contextual situation corresponding to the activity; and
select the different primary device to coordinate and control the actions of the secondary devices to perform the activity under the new contextual situation corresponding to the activity in response to determining that selection of the different primary device is needed based on the new contextual situation corresponding to the activity.

15. A computer program product for multi-device ecosystem management, the computer program product comprising a computer-readable storage medium having program instructions embodied therewith, the program instructions executable by a set of processors in a multi-device ecosystem to cause the set of processors to perform a method of:
identifying a plurality of devices in a multi-device ecosystem, including a set of specifications and a relative position corresponding to each respective device of the plurality of devices, wherein the multi-device ecosystem works together to perform an activity;
selecting a primary device from the plurality of devices in the multi-device ecosystem based on an analysis of the set of specifications and the relative position corresponding to each respective device, wherein the primary device has sufficient data processing capabilities to coordinate and control actions of secondary devices in the multi-device ecosystem and has a communication connection with each of the secondary devices to facilitate completion of the activity;
determining a set of requirements to complete the activity by the multi-device ecosystem; and
completing the activity in accordance with the set of requirements by the multi-device ecosystem as coordinated and controlled by the primary device.

16. The computer program product of claim 15, further comprising:
recording data corresponding to the completion of the activity by the primary device and the secondary devices of the multi-device ecosystem under a current contextual situation corresponding to the activity; and
updating a knowledge corpus of each respective device of the plurality of devices in the multi-device ecosystem with the data corresponding to the completion of the activity under the current contextual situation corresponding to the activity.

17. The computer program product of claim 15, further comprising:
performing an analysis of a knowledge corpus of the primary device selected to coordinate and control actions of the secondary devices to perform the activity under a current contextual situation corresponding to the activity;
detecting that the primary device does not have needed information to coordinate and control the actions of the secondary devices to perform the activity under the current contextual situation corresponding to the activity based on the analysis of the knowledge corpus of the primary device; and
adding by a secondary device the needed information to the knowledge corpus of the primary device for coordinating and controlling the actions of the secondary devices to perform the activity under the current contextual situation corresponding to the activity.

18. The computer program product of claim 15, further comprising:
determining that the primary device is leaving the multi-device ecosystem; and
sharing by the primary device a knowledge corpus of the primary device with a newly selected primary device for continued coordination and control of the secondary devices to perform the activity under a current contextual situation without interruption prior to the primary device leaving the multi-device ecosystem.

19. The computer program product of claim 15, further comprising:
detecting that a current contextual situation corresponding to the activity has changed to a new contextual situation in relation to the primary device and the secondary devices of the multi-device ecosystem;
determining whether selection of a different primary device is needed based on the new contextual situation corresponding to the activity; and
selecting the different primary device to coordinate and control the actions of the secondary devices to perform the activity under the new contextual situation corresponding to the activity in response to determining that selection of the different primary device is needed based on the new contextual situation corresponding to the activity.

20. The computer program product of claim 19, further comprising:
changing to the different primary device to coordinate and control the actions of the secondary devices to perform the activity under the new contextual situation corresponding to the activity prior to completion of the activity.
